(19) United States
(12) Patent Application Publication
(10) Pub. No.: US 2003/0125458 A1
(43) Pub. Date: Jul. 3, 2003

(54) Process for producing cellulose/plastic composites and product of the process

(76) Inventors: Lothar Thiele, Leichlingen (DE); Hans-Peter Kohlstadt, Velbert (DE); Hans Reinhard Striewski, Fockbek (DE)

Correspondence Address: Stephen D. Harper, Henkel Corporation, Law Department, 2500 Renaissance Blvd., Suite 200, Gulph Mills, PA, 19406, US

(21) Appl. No.: 10/345,711

(22) Filed: Jan. 16, 2003

Related U.S. Application Data
(63) Continuation of application No. 08/983,374, filed on Jan. 16, 1998, now abandoned.
Application No. 08/983,374 is a 371 of international application No. PCT/EP96/03007, filed on Jul. 10, 1996.

(30) Foreign Application Priority Data
Jul. 17, 1995 (DE) 195 26 032.5

(51) Int. Cl. C08K 3/00

(52) U.S. Cl. 524/733

(57) ABSTRACT

The invention is a process for producing a particulate cellulose containing composite and the product of the process. The composite is formed by mixing a cellulose containing material with a polyol and water to form a first mixture. The first mixture is mixed with an equivalent excess of a polyisocyanate to form a second mixture which is reacted under pressure of 1 Kg/cm² to 100 Kg/cm² at a temperature of 10° C. to 30° C. for from 5 minutes to 30 minutes to form the composite.

This invention relates to formaldehyde-free plastic/wood composites having improved resistance to water, to their production and to their use.

According to Ullmann, Enzyklopädie der technischen Chemie, 4th Edition, Vol. 12, pages 709 et seq, wood-based materials may be divided into the following classes of semi-finished products:

Wood chip boards or particle boards are generally understood to be boards of mechanically produced chips of wood or wood-containing parts which are made by gluing under pressure with a binder. The synthetic resins or binders used are selected from urea resins or aminoplastics, phenolic resins or mixed resins of urea, melamine, phenol and formaldehyde. Isocyanates, particularly those based on diphenylmethane diisocyanate, and crosslinkable polymers are also used. The properties of chipboards can be varied through the size, shape and arrangement of the chips and the amount of synthetic resin or binder used (ca. 5-10%). High-quality boards comprise several layers with a surface layer of particularly fine particles. For use in furniture making, chipboards can be coated with decorative films, priming films and veneers. Here, a density-based distinction is drawn between flat-pressed boards with a medium density of 500 to 800 kg/m³ and light flat-pressed boards with a density of about 300 kg/m³.

CA 100:104746, which relates to JP-A-58185670, describes binders for chipboards based on a 4,4′-diphenylmethane diisocyanate fraction. According to this document, the chipboards are moistened with water so that the diisocyanate mentioned can be reacted during hot pressing at 150° C./25 kg/cm². The polyurethane-containing chipboards obtained have improved flexural strength.

Wood-fiber chipboards are made from wood fibers or lignocellulose-containing material. Under the effect of heat, moisture and mechanical pressure in fiberizing machines, the lignin-, cellulose and hemicellulose-containing raw material is broken down into its fiber-like, anatomical basic elements in the form of individual fibers and fiber bundles. In the course of the manufacturing process, the fibrous material is shaped, compacted and pressed. The matting of the fibers and the natural binding forces are primarily used for this purpose. The binding forces can be increased by adding binding and hydrophobicizing agents and by thermal and other aftertreatments. The physical and strength properties can thus be adapted to the intended application.

According to DIN 68 753, wood-fiber chipboards are divided into hard boards with a density of more than 800 kg m³, medium-hard boards with a density of more than 350 kg/M³ to 800 kg/m³ and porous boards with a density of 230 to 350 kg/M³. Both in the wet process and in the dry process, up to 25 kg of resin and 1.5 to 20 kg of paraffin—per tonne of wood-fiber chipboard produced—are required for binding and hydrophobicizing. In the wet process predominantly in use today, the process water has to be circulated with a content of soluble material of up to 2.0-2.5% which is highly energy-intensive at a water temperature of up to 65° C. In addition, formaldehyde has to be added in a quantity of 0.02 to 0.2% to avoid troublesome staining of the wood-fiber chipboards by the highly concentrated circuit water.

At the present time, medium-hard wood-fiber chipboards are mainly marketed in semifinished form as medium-density fiberboards (MDFs) which are made with formaldehyde-containing condensation resins. However, through the continuous emission of carcinogenic formaldehyde vapors, in some cases for several years, products such as these are no longer wanted on ecological grounds. In the furniture industry, the situation is remedied by giving MDFs an additional coating to bring the emission of formaldehyde below the legally specified limits. In addition, although MDFs have better dimensional stability than natural wood at typical air humidity levels of 35 to 85%, it is still not good enough for certain applications. In addition, MDFs made with synthetic urea-formaldehyde binders are not suitable for use in high-humidity environments, particularly in water.

Wood/plastic composites are understood to be wood/plastic combinations which are obtained by treating wood with monomers or prepolymers. They are composite materials where the wood is impregnated with the liquid starting material and the monomer deposited in the wood is subsequently polymerized. Liquid monomers and solutions, for example methacrylate prepolymers or unsaturated polyesters dissolved in styrene, are preferably used in practice. The polymers primarily increase the strength of the wood, above all its hardness and its compressive strength. Finally, the aesthetic effect of natural wood not only is not impaired, it is actually enhanced in many cases. Despite these advantages, wood/plastic composites have hitherto been used to only a very limited extent for special applications, for example for parquet floors, sports equipment, kitchen utensils and tool handles.

In contrast to the pure impregnating process for making wood/plastic composites, the skinpreg process comprises surface impregnation with plastics which penetrate into the wood to different depths under light pressure without completely impregnating it.

CA 111:59849, which relates to JP-A-01045440, describes isocyanate- or formaldehyde-based wood/foam compositions which contain sawdust as filler. The foam obtained, with a density of 0.35 g/cm³, possesses very high strength. The sawdust or wood powder is normally very finely size-reduced wood which is used as a filter aid, as a filler, as an additive for rough fiber coatings, etc. However, there is nothing in the literature reference in question to suggest that the foam is produced under high pressure. Solvents are used.

CA 111:9171, which relates to JP-A-63303703, describes composites of fine vegetable fibers or vegetable particles, more particularly wood powder, and a urethane prepolymer which are contacted with water or steam before or after molding. A composite of this type has a density of 0.29 g/cm³, a compressive strength of 5.3 kg/cm² and a tensile strength of 3.4 kg/cm². However, there is nothing in this literature reference which directly or indirectly suggests that the composites are produced at above-atmospheric pressure. Solvents are used.

Accordingly, the problem addressed by the present invention was to provide a new wood/plastic composite which would avoid the use of the formaldehyde-containing binders still absolutely essential in the MDFs mainly in use today and which would also have advantageous performance properties.

This problem has been solved by the features of claim 1.

Accordingly, the present invention relates to a wood/plastic composite based on wood particles and/or cellulose-containing material and at least one binder, the binder being a carbon-dioxide-eliminating two-component polyurethane binder of a polyol, water and a polyisocyanate, characterized in that the binder is present in a quantity of 10 to 200 parts by weight, based on 100 parts by weight of the wood particles and/or the cellulose-containing material, the composite being obtainable by reaction of the wood particles and/or the cellulose-containing material and the binder under a pressure of at least 1 kp/cm² and, more particularly, in the range from 50 to 100 kp/cm².

In view of the marked increase in the hardness of the wood, even in the interior of the composite, it is assumed that—depending on the ratio by weight of wood to binder, the size of the wood particles and the pressure applied—the wood is strengthened by the polyurethane at its surface or throughout, i.e. the wood is present as a wood/plastic composite.

The wood/plastic composite has the following advantages over the prior art:

In contrast to the known wood-based materials mentioned above, it can be made in any form, i.e. made-to-measure, for example in the form of boards, strips, cubes, squares, etc.

It is suitable as a lightweight building material because it normally has a density of 0.40 to 0.65 g/cm³. It is therefore a substitute for light and medium flat-pressed boards or medium-hard wood-fiber chipboards, but without the attendant formaldehyde problems.

It does not swell in water at room temperature, i.e. its increase in thickness after 24 hours in water at 20° C. is <4 or 1% for thicknesses of 6 to 12 or >35 mm.

In contrast to many of the wood-based materials and MDF boards still in use today, it is formaldehyde-free and flame-retardant.

The composites are so elastic that 5 mm diameter timber screws can be screwed in without any splintering.

The composites are also so dimensionally stable that threads can be cut for Spax screws, i.e. screws with a broad thread.

By virtue of the polyurethane present, the composites may readily be painted.

Finally, the composites are characterized by their homogeneity, i.e. there is none of the otherwise usual layer formation; in particular, there is no inner layer and outer layer.

In one preferred embodiment of the wood/plastic composite according to the invention, soft woods, for example woods of the spruce, pine, fir, larch, birch, alder, horse chestnut, aspen, willow, poplar and lime, are used as the wood starting material. However, hard woods, for example beech, hawthorn, blackthorn, ash, maple, walnut, apple, pear, yew or oak, may also be used. Mixtures of soft wood and hard wood may also be used.

In another preferred embodiment, vegetable fibers, for example cotton, jute, flax, hemp, bast, sisal, ramie, coconut fibers, yucca fibers or manila, or chemically modified fibers, such as the viscose fibers rayon and rayon staple, cuoxam fibers, acetate fibers, and paper and cellulose yarns, may be used as the cellulose-containing material in the composite according to the invention.

The wood particles are present in the composite according to the invention in the form of wood chips and/or wood particles or as cellulose-containing material in particle sizes of at most 5 mm (thickness)×20 mm (width)×50 mm (length). A thickness range of 0.5 to 3 mm, a width range of 1 to 15 mm and a length range of 3 to 40 mm are preferred.

The moisture content of the wood particles or cellulose-containing material in the composite according to the invention is normally from 5 to 20% by weight. If desired, it may be increased by moistening with water or steam or reduced by drying at elevated temperature. However, the moisture content preferably corresponds to the equilibrium moisture content of the material at ambient temperature.

The composites according to the invention may contain wires, cables, wire nets, rods or the like, for example for stabilization.

The two-component polyurethane binder used in the composite according to the invention consists of a reaction product of at least one polyol with at least one polyisocyanate.

The quantity in which the two reactants are used is always selected so that the polyisocyanate is present in excess, i.e. the equivalent ratio of NCO groups to OH groups is 5:1 and preferably 2:1 to 1.2:1.

The polyisocyanate used is normally an aliphatic, alicyclic or aromatic diisocyanate or triisocyanate.

The polyisocyanates preferably contain on average 2 to at most 4 NCO groups. Examples of suitable isocyanates are 1,5-naphthylene diisocyanate, 4,4′-diphenylmethane diisocyanate (MDI), hydrogenated MDI (H₁₂MDI), xylylene diisocyanate (XDI), tetramethyl xylylene diisocyanate (TMXDI), 4,4′-diphenyl dimethyl methane diisocyanate, di- and tetraalkyl diphenylmethane diisocyanate, 4,4′-dibenzyl diisocyanate, 1,3-phenylene diisocyanate, 1,4-phenylene diisocyanate, the isomers of tolylene diisocyanate (TDI), optionally in admixture, 1-methyl-2,4-diisocyanatocyclohexane, 1,6-diisocyanato-2,2,4-trimethyl hexane, 1,6-diisocyanato-2,4,4-trimethyl hexane, 1-isocyanatomethyl-3-isocyanato-1,5,5-trimethyl cyclohexane (IPDI), chlorinated and brominated diisocyanates, phosphorus-containing diisocyanates, 4,4′-diisocyanatophenyl perfluoroethane, tetramethoxybutane-1,4-diisocyanate, butane-1,4-diisocyanate, hexane-1,6-diisocyanate (HDI), dicyclohexylmethane diisocyanate, cyclohexane-1,4-diisocyanate, ethylene diisocyanate, phthalic acid-bis-isocyanatoethyl ester. Other important diisocyanates are trimethyl hexamethylene diisocyanate, 1,4-diisocyanatobutane, 1,12-diisocyanatododecane and dimer fatty acid diisocyanate. Also of interest are partly masked polyisocyanates which enable self-crosslinking polyurethanes to be formed, for example dimeric tolylene diisocyanate. Finally, prepolymers, i.e. oligomers containing several isocyanate groups, may also be used. Prepolymers are obtained using a large excess of monomeric polyisocyanate, for example in the presence of diols. Isocyanuratization products of HDI and biuretization products of HDI may also be used.

The diisocyanates or polyisocyanates preferably used are aromatic isocyanates, for example diphenylmethane diisocyanate, either in the form of the pure isomers or in the form of a mixture of the 2,4′- and 4,4′-isomers, or even carbodiimide-liquefied diphenylmethane diisocyanate (MDI) which is commercially available, for example, as Isonate 143 L. The so-called “crude MDI”, i.e. the isomer/oligomer mixture of MDI commercially available, for example, as PAPI or Desmodur VK may also be used. In addition, so-called “quasi prepolymers”, i.e. reaction products of MDI or tolylene diisocyanate (TDI) with low molecular weight diols, for example ethylene glycol, diethylene glycol, propylene glycol, dipropylene glycol or triethylene glycol, are also suitable.

Preferred diols and/or polyols for the binder are the liquid polyhydroxy compounds containing two or three hydroxyl groups per molecule, for example difunctional and/or trifunctional polypropylene glycols with molecular weights in the range from 200 to 6,000 and preferably in the range from 400 to 3,000. Statistical and/or block copolymers of ethylene oxide and propylene oxide may also be used. Another group of preferred polyether polyols are the polytetramethylene glycols which are obtained, for example, by acidic polymerization of tetrahydrofuran. The molecular weight of the polytetramethylene glycols is in the range from 200 to 6,000 and preferably in the range from 40 to 4,000.

Other suitable polyols are the liquid polyesters which may be obtained by condensation of di- and tricarboxylic acids, for example adipic acid, sebacic acid and glutaric acid, with low molecular weight diols and triols, for example ethylene glycol, propylene glycol, diethylene glycol, triethylene glycol, dipropylene glycol, butane-1,4-diol, hexane-1,6-diol, glycerol or trimethylol propane.

Another group of polyols suitable for use in accordance with the invention are the polyesters based on ε-caprolactone which are also known as “polycaprolactones”.

However, polyester polyols of oleochemical origin may also be used. Oleochemical polyester polyols may be obtained, for example, by complete ring opening of epoxidized triglycerides of an at least partly olefinically unsaturated fatty-acid-containing fatty mixture with one or more alcohols containing 1 to 12 carbon atoms and subsequent partial transesterification of the triglyceride derivatives to form alkyl ester polyols containing 1 to 12 carbon atoms in the alkyl group. Other suitable polyols are polycarbonate polyols and dimer diols (Henkel KGaA) and, in particular, castor oil and derivatives thereof. The hydroxyfunctional polybutadienes commercially obtainable, for example as “Poly-bd” may also be used as polyols for the composites according to the invention.

The present invention also relates to a process for producing the wood/plastic composites in which the wood particles and/or the cellulose-containing material are/is first mixed with the polyol component, the other component(s), more particularly the polyisocyanate in excess, is/are added to the resulting mixture, the mixture is homogenized and then introduced into a closable, pressure-tight mold optionally coated with release agents, the reaction mixture is reacted under a pressure of at least 1 kp/cm² and the composite is removed or freed from the mold after cooling.

The mixing and reaction steps mentioned above are carried out at temperatures of 10 to 30° C. and more particularly at room temperature (18 to 25° C.). The pressure treatment in the process according to the invention is sourced by the reaction of the reaction mixture under the natural reaction pressure. If necessary, however, pressure may also be supplied from outside in known manner in the form of an inert gas or even steam.

In the process according to the invention, the reaction in the mold and hence the formation of the composite takes 5 to 30 minutes and preferably 10 to 20 minutes.

Closable pressure-tight molds are used in the process according to the invention.

There is normally no need to provide a release agent, more particularly in the form of a Teflon® coating, between the pressure reactor and the composite. In certain cases, however, type 39-5001, 394487, 37-3200 and 36-3182 Acmos release agents for PUR are preferably used.

Finally, the present invention relates to the use of composites of the type mentioned above or produced by the process described above in the form of boards, strips, cubes, squares etc., more particularly in humid environments or outdoors. The present invention also relates to the use of the composites obtainable by the process described above as semi-finished products or for cladding purposes in the building industry. The composites according to the invention may also be used as a packaging material, as a floor covering, as stairs or as ornamental beams. These uses of the composites preferably involve the interior fitting-out of vehicles, more particularly motor vehicles, such as automobiles and camping vehicles, but also caravans, ships and aircraft. Alternatively, the composites according to the invention may be used for decorative purposes outdoors or in the domestic and institutional sectors, more particularly in kitchens and bathrooms.

The invention is illustrated by the following Examples.

### EXAMPLE 1

A) Starting Products

| | |
|---|---|
| a) Polyol component: | |
| trifunctional polyether polyol based on glycerol, | 83.8 |
| ethylene oxide and propylene oxide | |
| glycerol | 6.0 |
| soya polyol modified with ethylene oxide | 6.0 |
| water | 2.2 |
| Tegostab B 8404 (Goldschmidt) | 1.3 |
| dibutyl tin dilaurate | 0.7 |
| b) Isocyanate component: | |
| diphenylmethane-4,4′-diisocyanate | 100 |
| (crude MDI with a viscosity of 200 to 220 mPas) | |

B) Production

1500 g of wood chips (pine) up to 4 cm in length are intensively mixed with 1,000 g of the polyol component of the foam system. After addition of 1,000 g of the isocyanate and remixing, the mixture was quickly introduced into a metal mold around 6.5 dm³ in size. The mold was immediately closed with a cover. After 30 minutes the foam-containing wood/plastic composite is removed from the mold.

The composite obtained has a density of 0.6 g/cm³ and a smooth surface and can be mechanically treated like wood, for example sawn, planed, sanded and drilled. Threads can also be cut into the material.

C) Application

The composite obtained in accordance with the Production Example was compared for quality with a medium-density fiberboard (MDF board) which had been produced with formaldehyde-containing condensation resins and had exactly the same thickness. It was found above all that the composite according to the invention has significantly lower water absorption than the MDF board.

TABLE
Water absorption and swelling of the composites according to
the invention compared with MDF boards

| | Density | Water absorption | | Increase in | |
|---|---|---|---|---|---|
| | [g/cm] | [%] | | thickness [%] | |
| | | After storage in water for 24 h | | | |
| Board thickness | | 6-12 | >35 | 6-12 | >35 |
| [mm] | | | | | |
| MDF board | 0.72 | 20 | 16 | 8 | 5 |
| Composite | 0.60 | 14 | 7.5 | 4 | 1 |
| according to the | | | | | |
| invention | | | | | |

1. Wood-plastic composites based on wood particles and/or cellulose-containing material and at least one binder, the binder being a carbon-dioxide-eliminating two-component polyurethane binder of a polyol, water and a polyisocyanate, characterized in that the binder is present in a quantity of 10 to 200 parts by weight, based on 100 parts by weight of the wood particles and/or the cellulose-containing material, the composite being obtainable by reaction of the wood particles and/or the cellulose-containing material and the binder under a pressure of at least 1 kp/cm² and, more particularly, in the range from 50 to 100 kp/cm².

2. Composites as claimed in claim 1, characterized in that soft woods, for example needle woods or hard woods, for example beech or oak, are used as the wood starting material for the wood particles.

3. Composites as claimed in at least one of the preceding claims, characterized in that vegetable fibers, such as cotton, jute, flax, hemp, or chemically modified fibers, such as rayon staple, are used as the cellulose-containing material.

4. Composites as claimed in at least one of the preceding claims, characterized in that the wood particles are used in the form of wood chips or wood powder with particle sizes of at most 1 mm (thickness)×20 mm (width)×50 mm (length).

5. Composites as claimed in at least one of the preceding claims, characterized in that the moisture content of the wood particles and/or the cellulose-containing material is between 5 and 2% by weight.

6. Composites as claimed in at least one of the preceding claims, characterized in that they additionally contain inserts or strengtheners, for example in the form of wires, cables, wire nets or rods.

7. Composites as claimed in at least one of the preceding claims, characterized in that the polyisocyanate is a diisocyanate or triisocyanate, more particularly diphenylmethane-2,2′-diisocyanate (as the crude product).

8. Composites as claimed in at least one of the preceding claims, characterized in that the polyol is a diol/triol mixture of polyether and polyester polyols with water.

9. Composites as claimed in at least one of the preceding claims, characterized in that they have a density of 0.40 g/cm³ to 0.65 g/cm³.

10. A process for the production of the composites claimed in the preceding claims, characterized in that
a) the wood particles and/or the cellulose-containing material are/is first mixed with the polyol component,
b) the other component(s), more particularly the polyisocyanate in excess, is/are added to the resulting mixture and the mixture is homogenized,
c) the mixture is introduced into a closable pressure-tight mold optionally coated with release agents and the reaction mixture is reacted under a pressure of at least 1 kg/cm³ and
d) the molding is removed from or freed from the mold.

11. A process as claimed in claim 10, characterized in that in that steps (a) to (c) are carried out at temperatures of 10 to 30° C. and more particularly at room temperature (18 to 25° C.).

12. A process as claimed in claim 10, characterized in that the reaction of the reaction mixture in step (c) takes place under the natural reaction pressure.

13. A process as claimed in claim 10, characterized in that the reaction time in step (c) is 5 to 30 minutes and preferably 10 to 20 minutes.

14. A process as claimed in at least one of claims 10 to 13, characterized in that a closable metal or plastic mold is used as the mold.

15. The use of the composites claimed in at least one of claims 1 to 9 or produced by the process claimed in at least one of claims 10 to 14 in the form of boards, strips, cubes, squares, etc., more particularly in humid environments or outdoors.

16. The use of the composites claimed in at least one of claims 1 to 9 or produced by the process claimed in at least one of claims 10 to 14 as a semi-finished product or as cladding in the building industry.

17. The use of the composites in at least one of claims 1 to 9 or produced by the process claimed in at least one of claims 10 to 14 as a packaging material, floor covering, stairs or decorative beams.

18. The use of composites as claimed in claim 17 for the interior fitting out of vehicles, more particularly motor vehicles, such as automobiles and camping vehicles but also caravans, ships and aircraft.

19. The use of composites as claimed in claim 16 for decorative purposes outdoors or in the domestic and institutional sectors, particularly in kitchens and bathrooms.
